(19) United States
(12) Patent Application Publication
(10) Pub. No.: US 2009/0186759 A1
(43) Pub. Date: Jul. 23, 2009

(54) Thermochromic material

(76) Inventor: Ping-Kun Lin, Changhua County (TW)

Correspondence Address: Ping-Ku Lin, P.O. Box 44-2049, Taipei, 10668, TW

(21) Appl. No.: 12/010,115

(22) Filed: Jan. 22, 2008

(51) Int. Cl. B41M 5/28

(52) U.S. Cl. 503/215

(57) ABSTRACT

A thermochromic material mainly includes a fabric base, a thermosensitive coating layer formed by printing thermochromic paint on at least one portion of a surface of the fabric base, and a film layer adhered to a surface of the thermosensitive coating layer. The film layer is formed by fusing and mixing a thermoplastic polyurethane (TPU) material and an UV-cut material to obtain a fused material and then printing the fused material in a sheet-like manner. The film layer has a thickness ranging from 0.08 mm to 3 mm.

### BACKGROUND OF THE INVENTION

(1) Field of the Invention

The invention relates to a thermochromic material, and more particularly to a material having UV-cut and thermochromic properties.

(2) Description of the Prior Art

The thermosensitive coating available in the market is applied to a surface of clothes or decoration by way of screen printing according to the requirement and the glory so that different patterns can be formed and the color can change when the temperature varies.

However, the thermosensitive coating has the low daylight fastness. Thus, if the thermosensitive coating is exposed to the outdoor environment for a long time, the thermochromic function may fail so that the color changing property is lost. In addition, the thermosensitive coating tends to be peeled off due to the repeated cleaning, and the thermochromic function is also lost.

Thus, the manufacturer has developed a material surface printed with the thermosensitive coating and coated with a protection film of an acrylic adhesive. In addition, an UV-cut material is also coated on a surface of the protection film in order to make the material have the UV-cut ability so that the material can be used in the outdoor environment for a long time.

When the above-mentioned technology is applied, the technological drawback tends to be induced.

The first drawback is the complicated manufacturing processes. Because the material must have a predetermined thickness in order to prevent the material from being damaged by the UV light, multiple layers of UV-cut paint have to be coated so that more manufacturing steps of artificial works have to be performed. Correspondingly, a lot of UV-cut paint has to be consumed so that the cost is increased and the margin of the manufacturer is decreased.

The second drawback is the deteriorated visibility because the UV-cut paint layer cannot have the predetermined thickness until the multiple layers are coated. Thus, the pattern formed in the thermosensitive coating under the UV-cut paint layer cannot be easily seen.

The third drawback is that the UV-cut paint layer coated on the outermost layer tends to be worn when the material is used or cleaned. Thus, the previous protecting effect is lost. Generally speaking, the thermosensitive material with the UV-cut means is not very ideal and still has to be improved.

### SUMMARY OF THE INVENTION

A main object of the invention is to provide a thermochromic material with an UV-cut protecting effect.

The invention achieves the above-identified object by providing a thermochromic material. The thermochromic material mainly includes a fabric base, a thermosensitive coating layer formed by printing thermochromic paint on at least one portion of a surface of the fabric base, and a film layer adhered to a surface of the thermosensitive coating layer. The film layer is formed by fusing and mixing a thermoplastic polyurethane (TPU) material and an UV-cut material to obtain a fused material and then printing the fused material in a sheet-like manner. The film layer has a thickness ranging from 0.08 mm to 3 mm. The thermochromic material has the following features.

First, the UV-cut material and the TPU material are mixed and fused and then formed into the film layer in this invention. At this time, the film layer has the UV-cut property. Because the film layer has the predetermined thickness, the UV-cut material may be thinned with the TPU material to prevent the color of the UV-cut material from deteriorating the visibility. Furthermore, the thick film layer can effectively enhance the UV-cut intensity.

Second, the UV-cut material and the TPU material are mixed and fused so that the scratch-proof and UV-cut properties are obtained. In addition, the film layer can prevent the thermochromic material from failing.

Third, the thermosensitive coating layer of the invention is interposed between the film layer and the fabric base, so it is possible to prevent the thermosensitive coating layer from being worn externally.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematically exploded view showing the invention.

FIG. 2 is a cross-sectional view showing the invention.

FIG. 3 is a schematically assembled view showing the invention.

### DETAILED DESCRIPTION OF THE PREFERRED EMBODIMENTS

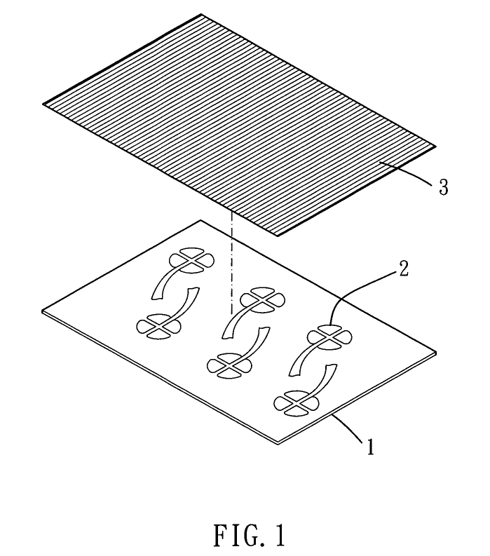

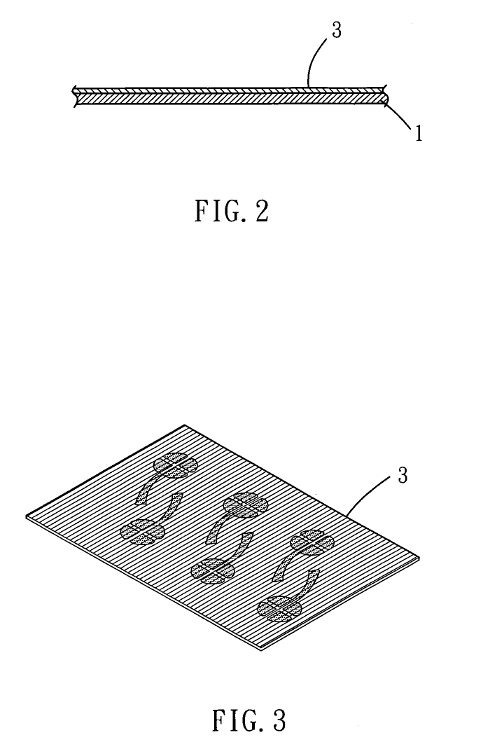

FIG. 1 is a schematically exploded view showing the invention. FIG. 2 is a cross-sectional view showing the invention. As shown in FIGS. 1 and 2, a sheet-like fabric base 1 is selected. The fabric base 1 is mainly composed of a fibric material. In addition, a thermosensitive coating layer 2 composed of a thermochromic material, which has different colors at different temperatures, is printed on at least one portion of a surface of the fabric base 1. In addition, the thermosensitive coating layer 2 can be entirely printed on the surface of the fabric base 1 according to the requirement of use.

A thermoplastic polyurethane (TPU) material and an UV-cut material are fused and mixed to obtain a fused material. Next, the fused material is printed in a sheet-like manner to form a film layer 3. The film layer 3 is adhered to a surface of the thermosensitive coating layer 2 so that the material with the UV-cut and thermochromic properties can be obtained. The film layer 3 preferably has a thickness ranging from 0.08 to 3 mm. If the thickness is increased, the thermosensitive effect is correspondingly decreased.

As shown in FIG. 3, a surface of the film layer 3 may be embossed according to the requirement of use. An embossing roller (not shown) embosses the surface of the film layer 3 to form a transversal concave-convex special pattern so that the material having the rich design pattern, the UV-cut property and the thermochromic property can be obtained.

In this embodiment, the thermosensitive coating layer 2 has a flower-shaped pattern. The color of the thermosensitive coating layer is the same as that of the surface of the fabric base 1 when the thermosensitive coating layer is not heated. Thus, the pattern cannot be seen when no temperature variation occurs. The flower-shaped pattern can be seen on the fabric base when the temperature variation occurs because the color of the thermosensitive coating layer 2 is changed.

According to the thermochromic material of the invention, the element with the thermosensitive material is designed on the surface of the material, and the thermosensitive material and the UV-cut material are formed on the film layer 3. Thus, the material has the technological sense and the rich variation so that the overall quality of the material is enhanced a lot. In addition, the thermochromic material has the UV-cut effect so that the thermosensitive coating layer 2 can work for a longer period of time, the daylight fastness of the facture becomes higher, and the thermochromic lifetime can be lengthened.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A thermochromic material, mainly comprising:
a fabric base made of a fibric material;
a thermosensitive coating layer formed by printing thermochromic paint on at least one portion of a surface of the fabric base; and
a film layer adhered to a surface of the thermosensitive coating layer, wherein the film layer is formed by fusing and mixing a thermoplastic polyurethane (TPU) material and an UV-cut material to obtain a fused material and then printing the fused material on the surface of the fabric base in a sheet-like manner, and the thermosensitive coating layer has a thickness ranging from 0.08 mm to 3 mm.

2. The thermochromic material according to claim 1, wherein the thermosensitive coating layer is formed by entirely printing the thermochromic paint on the surface of the fabric base.

3. The thermochromic material according to claim 1, wherein the thermosensitive coating layer is formed with a pattern.
